(19) United States
(12) Patent Application Publication
(10) Pub. No.: US 2016/0004660 A1
(43) Pub. Date: Jan. 7, 2016

(54) MEMORY SYSTEM AND DATA STORAGE DEVICE

(71) Applicant: SK hynix Inc., Gyeonggi-do (KR)

(72) Inventor: Hak Dae LEE, Gyeonggi-do (KR)

(21) Appl. No.: 14/504,165

(22) Filed: Oct. 1, 2014

(30) Foreign Application Priority Data
Jul. 4, 2014 (KR) 10-2014-0083598

(51) Int. Cl. G06F 13/40; G06F 13/42

(52) U.S. Cl. CPC G06F 13/4068; G06F 13/4221

(57) ABSTRACT

A memory system includes a first memory device and a second memory device suitable for outputting and receiving signals through first and second sub input/output lines, respectively, a controller suitable for outputting and receiving signals to and from the first memory device and the second memory device, through a main input/output line and a selection unit suitable for electrically coupling the main input/output line with one of the first and the second sub input/output lines, through which an activated one of the first memory and the second memory devices outputs and receives signals.

### CROSS-REFERENCES TO RELATED APPLICATION

The present application claims priority under 35 U.S.C, 119(a) to Korean application number 10-2014-0083598, filed on Jul. 4, 2014, in the Korean Intellectual Property Office, which is incorporated herein by reference in its entirety.

### BACKGROUND

1. Technical Field

Various embodiments of the present invention relate to a memory system and a data storage device capable of reducing power consumption and stably transmitting signals.

2. Related Art

The paradigm for the computer environment has shifted into ubiquitous computing so that computer systems can be used anytime and anywhere. The use of portable electronic devices such as mobile phones, digital cameras, and notebook computers has rapidly increased. In general, such portable electronic devices use a memory system or a data storage device which uses a memory device. The memory system or the data storage device is used to store data used in the portable electronic devices.

A memory system or data storage device may provide excellent stability, durability, high information access speed, and low power consumption, since there are no moving parts. Memory systems or data storage devices having such advantages include a universal serial bus (USB) memory device, memory cards having various interfaces, a universal flash storage (UFS) device, and a solid state drive (SSD).

As large capacity files such as music files and video files are used in a portable electronic device, a memory system or a data storage device is also required to have large storage capacity. In order to increase storage capacity, the memory system or the data storage device includes a plurality of memory devices. In order to increase the operation speed of the memory system or the data storage device, some memory devices thereof may share signal fines and operate in parallel. In this case, because signals are transmitted even to memory devices which do not need to be activated, this may result in unnecessary power consumption.

### SUMMARY

Various embodiments of the present invention are directed to a memory system and a data storage device capable of reducing power consumption and stably transmitting signals.

In an embodiment, a memory system may include a first memory device and a second memory device suitable for outputting and receiving signals through first and second sub input/output lines, respectively, a controller suitable for outputting and receiving signals to and from the first memory device and the second memory device, through a main input/output line, and a selection unit suitable for electrically coupling the main input/output line with one of the first and second sub input/output line, through which an activated one of the first memory and second memory devices outputs and receives signals.

In an embodiment, a data storage device may include a memory control unit, a first memory device suitable for transmitting and receiving signals with the memory control unit through a first sub channel, a second memory device suitable for transmitting and receiving signals with the memory control unit through a second sub channel, and a first selection unit suitable for activating one of the first sub channel and the second sub channel, based on a first select signal for activating the first memory device and a second select signal for activating the second memory device.

In an embodiment, a data storage device may include a first multichip package including a first memory chip, a second memory chip, and a first selection unit which activates one of a first internal data bus electrically coupled to the first memory chip and a second internal data bus electrically coupled to the second memory chip, and a controller suitable for controlling the first multichip package for storing and reading of data.

According to the embodiments, the power consumption of a memory system and a data storage device may be reduced, and signals may be stably transmitted therein.

### BRIEF DESCRIPTION OF THE DRAWINGS

FIG. 1 is a block diagram illustrating an example of a memory system in accordance with an embodiment of the present invention.

FIG. 2 is a block diagram explaining the load capacitance of input/output lines activated in the memory system shown in FIG. 1.

FIG. 3 is a block diagram illustrating an example of a data storage device in accordance with an embodiment of the present invention.

FIG. 4 is a block diagram explaining the load capacitance of channels activated in the data storage device shown in FIG. 3.

FIG. 5 is a block diagram illustrating an example of a controller of the data storage device shown in FIG. 3.

FIG. 6 is a block diagram illustrating an example of a data storage device accordance with an embodiment of the present invention.

FIG. 7 is a block diagram explaining the load capacitance of input/output buses activated in the data storage device shown in FIG. 6.

FIG. 8 is a block diagram illustrating an example of a computer system in which the memory system or the data storage device in accordance with the embodiment is mounted.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and, in some instances, proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on”, “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

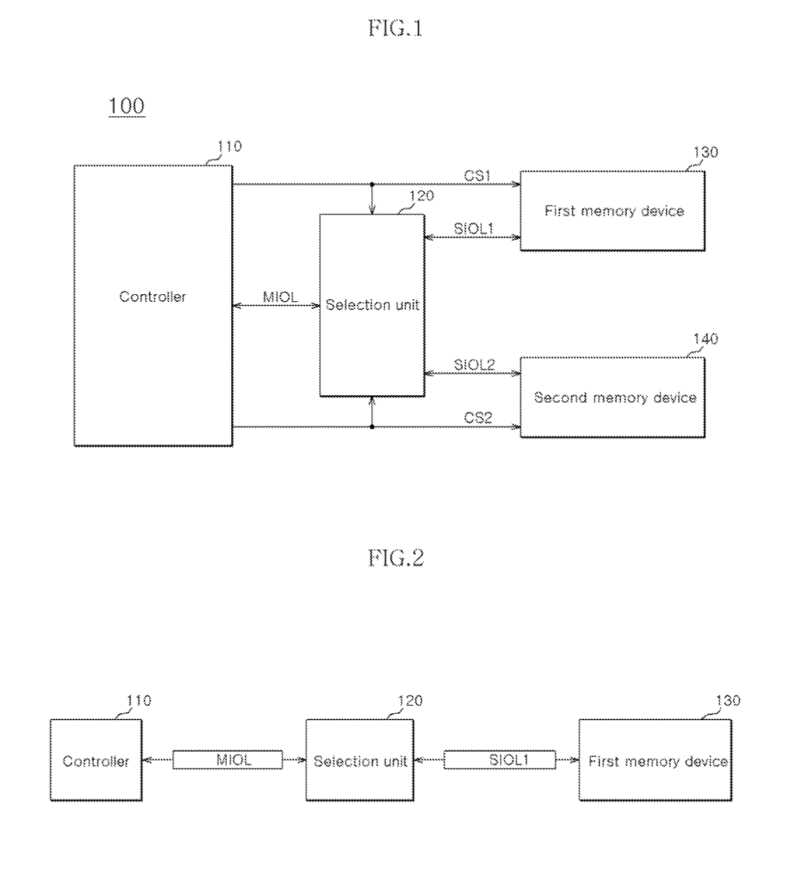

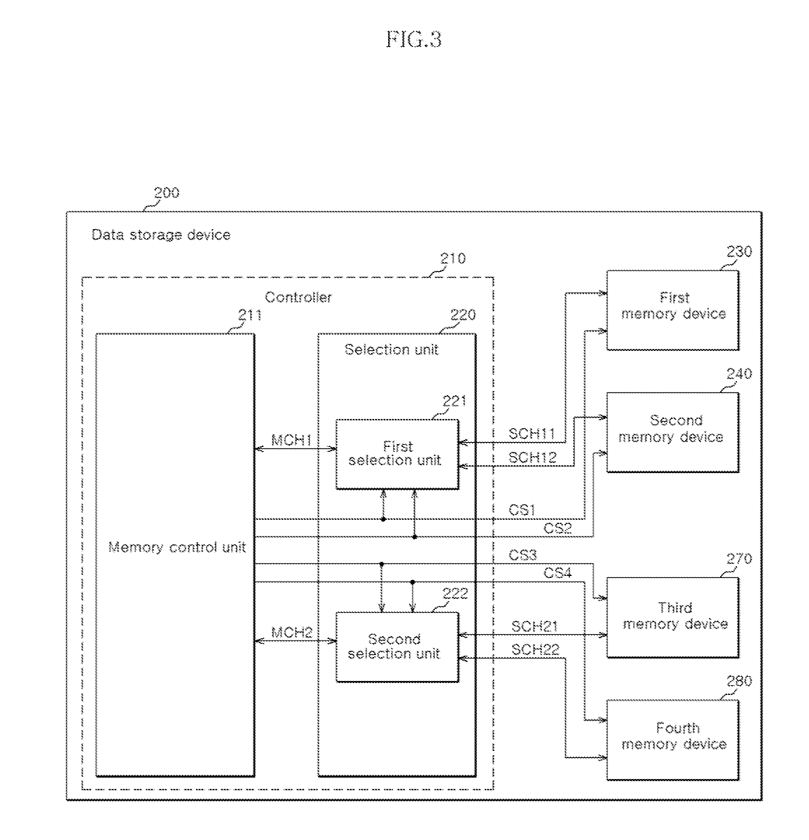

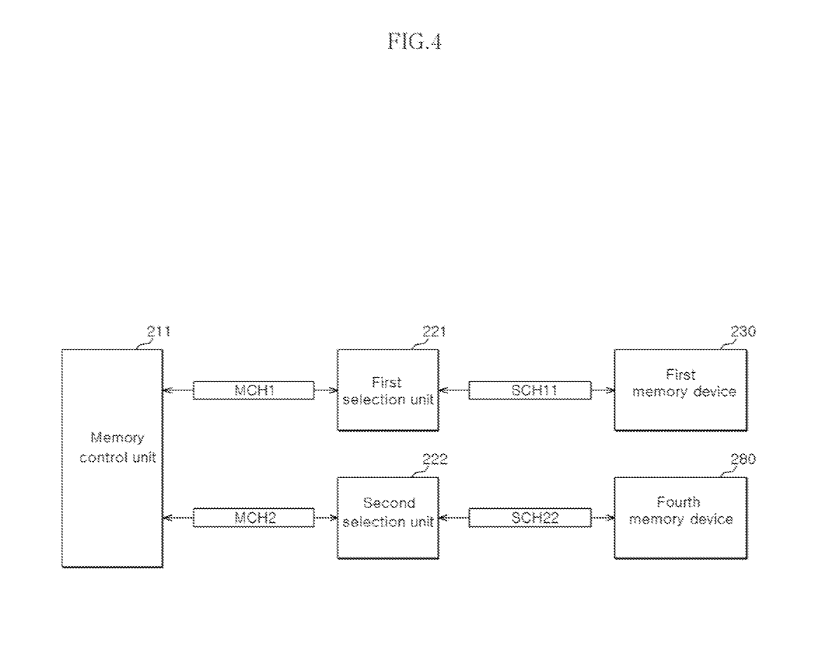

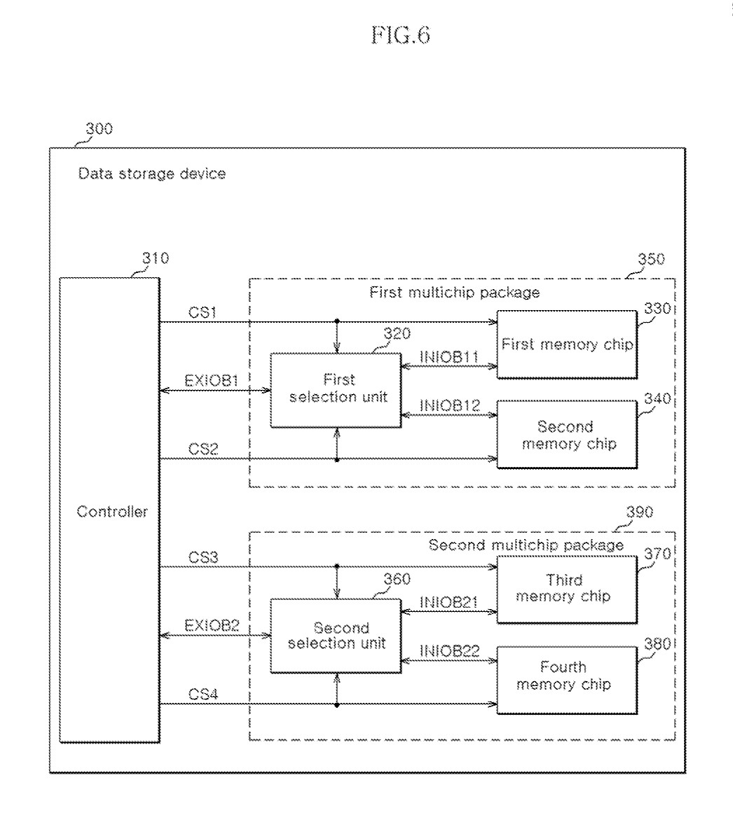

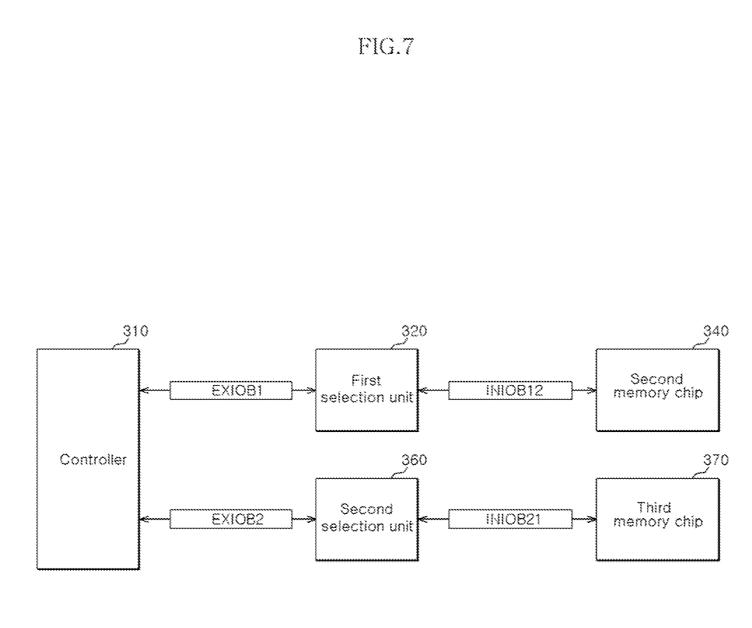

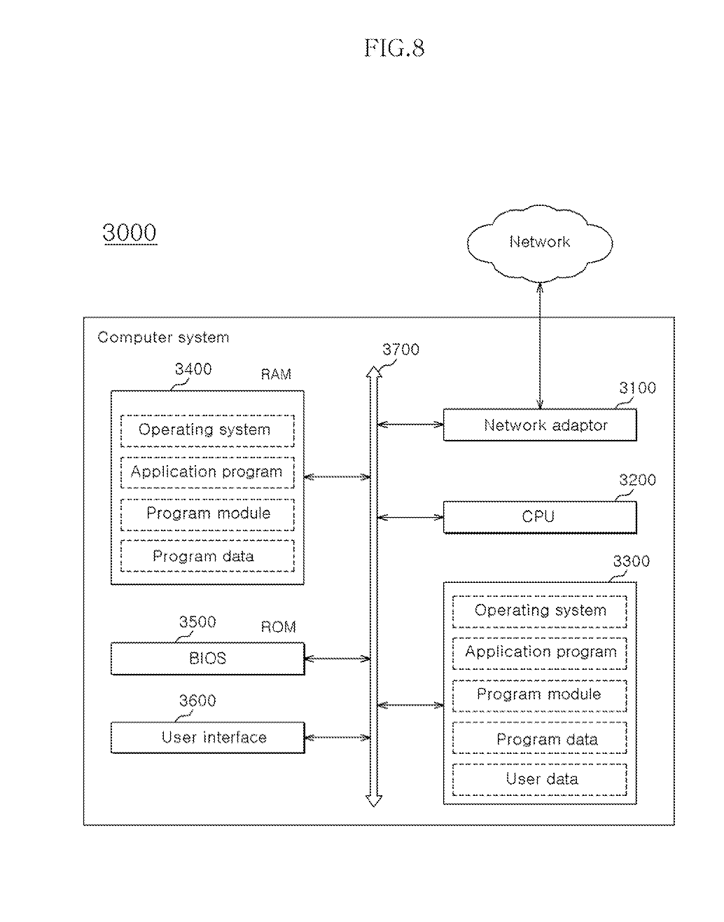

A signal line may be defined as an electrical path for transferring a signal from a device which transmits the signal to a device which receives the signal. The signal transferred through the signal line may include a control signal, a data signal, and so forth. In describing FIGS. 1 and 2, signal lines will be referred to as input/output lines. In describing FIGS. 3 to 5, signal lines will be referred to as channels. In describing FIGS. 6 and 7, signals lines will be referred to as input/output buses. That is to say, signal lines, input/output lines, channels, and input/output buses may be used as electrical paths for transferring signals (for example, control signals, data signals, and so forth).

Hereinafter, a memory system and a data storage device will be described below with reference to the accompanying drawings through various embodiments thereof.

FIG. 1 is a block diagram illustrating an example of a memory system in accordance with an embodiment of the present invention. FIG. 2 is a block diagram explaining the load capacitance of input/output lines activated in the memory system shown in FIG. 1.

A memory system 100 may store data to be accessed by a host device (not shown) such as a mobile phone, an MP3 player, a laptop computer, a desktop computer, a game player, a TV, an in-vehicle infotainment system, and so forth. Referring to FIG. 1, the memory system 100 may include a controller 110, a selection unit 120, a first memory device 130, and a second memory device 140.

The controller 110 may be configured by a micro control unit (MCU), a central processing unit (CPU), or the like. The controller 110 may control the first memory device 130 and the second memory device 140 by outputting control signals (for example, commands and addresses) through a main input/output line MIOL. When storing data, the controller 110 may output data to the first memory device 130 or the second memory device 140 through the main input/output line MIOL. Also, when reading data, the controller 110 may receive data from the first memory device 130 or the second memory device 140 through the main input/output line MIOL. The controller 110 may activate or deactivate the first memory device 130 and the second memory device 140 by activating or deactivating a first chip select signal CS1 and a second chip select signal CS2.

The selection unit 120 may activate any one of a first sub input/output line SIOL1 and a second sub input/output line SIOL2, based on the chip select signals CS1 and CS2. That is to say, the selection unit 120 may electrically couple any one of the first sub input/output line SIOL1 and the second sub input/output line SIOL2 with the main input/output line MIOL, based on the chip select signals CS1 and CS2. For example, when the first chip select signal CS1 is activated, the selection unit 120 may connect the main input/output line MIOL to the first sub input/output line SIOL1, and may disconnect the main input/output line MIOL from the second sub input/output line SIOL2. As another example, when the second chip select signal CS2 is activated, the selection unit 120 may connect the main input/output line MIOL to the second sub input/output line SIOL2, and may disconnect the main input/output line MIOL from the first sub input/output line SIOL1.

The first memory device 130 and the second memory device 140 may operate as the storage media of the memory system 100. Each of the first memory device 130 and the second memory device 140 may be configured by a volatile memory which loses the data stored therein when power is off or a nonvolatile memory which retains the data stored therein even though power is off. The volatile memory may include a static random access memory (SRAM) or a dynamic random access memory (DRAM). The nonvolatile memory may include a NAND flash memory, a NOR flash memory, a ferroelectric random access memory (FRAM), a magnetoresistive random access memory (MRAM), a phase change random access memory (PCRAM) or a resistive random access memory (ReRAM).

The first memory device 130 may be activated or deactivated in response to the first chip select signal CS1, and the second memory device 140 may be activated or deactivated in response to the second chip select signal CS2. The first memory device 130 which is activated in response to the first chip select signal CS1 may receive a control signal or data from the controller 110 or output the data read from memory cells to the controller 110, through the main input/output line MIOL and the first sub input/output line SIOL1. The second memory device 140 which is activated in response to the second chip select signal CS2 may receive a control signal or data from the controller 110 or output the data read from memory cells to the controller 110, through the main input/output line MIOL and the second sub input/output line SIOL2. In other words, the first memory device 130 and the second memory device 140 may share the main input/output line MIOL.

An input/output line which is configured by one or more signal lines may have load capacitance in proportion to the width, length and number of the signal lines. If the first and second memory devices 130 and 140 share the main input/output line MIOL without the selection unit 120, the load capacitance of input/output lines (that is, a main input/output line and sub input/output lines electrically coupled thereto) between the controller 110 and the first and second memory devices 130 and 140 may increase. This means that power consumption necessary for signal loading on the input/output lines may increase.

According to the embodiment, since only the main input/output line MIOL which is electrically coupled with the controller 110 and a sub input/output line SIOL1 or SIOL2 which is electrically coupled with an activated memory device 130 or 140 are electrically coupled with each other by the switching operation of the selection unit 120, the load capacitance of input/output lines to be driven by the controller 110 to output signals may be decreased. This means that not only power consumption necessary for signal loading may be decreased but also signal's may be stably transmitted through the input/output lines.

When the first chip select signal CS1 is activated and the second chip select signal CS2 is deactivated, the main input/output line MIOL and the first sub input/output line SIOL1 may be electrically coupled with each other by the switching operation of the selection unit 120. As shown in FIG. 2, the load capacitance of input/output lines to be driven by the controller 110 to output signals may be determined based on only the load capacitance of the main input/output line MIOL and the load capacitance of the first sub input/output line SIOL1 excluding the load capacitance of the second sub input/output line SIOL2.

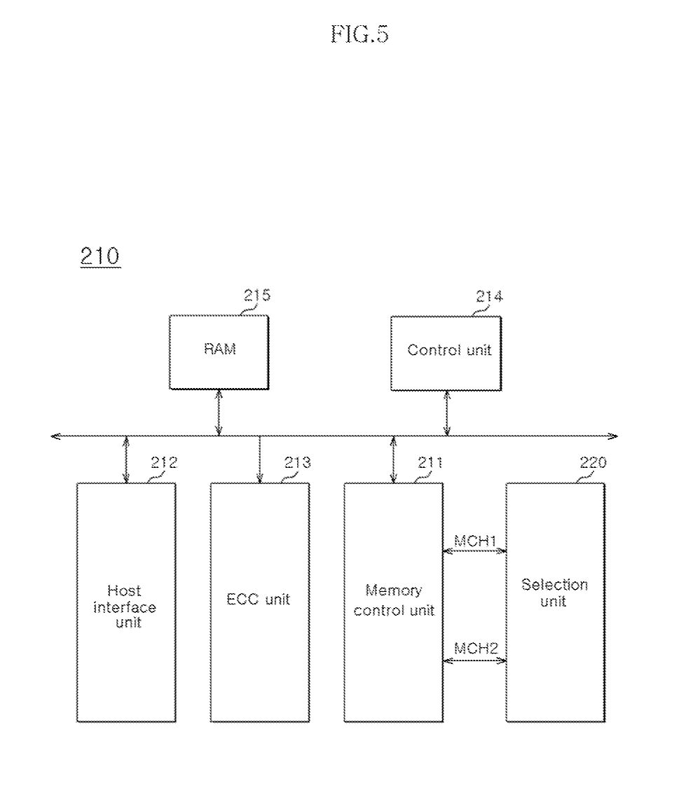

FIG. 3 is a block diagram illustrating an example of a data storage device in accordance with an embodiment of the present invention. FIG. 4 is a block diagram explaining the load capacitance of channels activated in the data storage device shown in FIG. 3.

A data storage device 200 may store data to be accessed by a host device (not shown) such as a mobile phone, an MP3 player, a laptop computer, a desktop computer, a game player, a TV, an in-vehicle infotainment system, and so forth. The data storage device 200 may also be referred to as a memory system.

The data storage device 200 may be manufactured as any one of various kinds of storage devices based on the protocol of an interface through which it is electrically coupled with the host device. For example, the data storage device 200 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, a smart media card, a memory stick, and so forth.

The data storage device 200 may be manufactured in any one of various kinds of package types. For example, the data storage device 200 may be manufactured as any one of various kinds of package types such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The data storage device 200 may include a controller 210, a first memory device 230, a second memory device 240, a third memory device 270, and a fourth memory device 280. The controller 210 may include a memory control unit 211 and a selection unit 220. The selection unit 220 may include a first selection unit 221 and a second selection unit 222.

The controller 210 may control the general operations of the data storage device 200 through driving of the firmware or the software loaded on a working memory device (not shown) which is disposed in the controller 210. The controller 210 may decode or drive a code-type instruction or algorithm such as firmware or software. The controller 210 may be realized in hardware or in a combination of hardware and software. The controller 210 may be configured by a micro control unit (MCU), a central processing unit (CPU), or the like. The controller 210 may control the first to fourth memory devices 230 to 280 through the memory control unit 211.

The memory control unit 211 may control the first memory device 230 and the second memory device 240 by providing control signals (for example, commands and addresses) through a first main channel MCH1. When storing data, the memory control unit 211 may provide data to the first memory device 230 or the second memory device 240 through the first main channel MCH1. Also, when reading data, the memory control unit 211 may be provided with data from the first memory device 230 or the second memory device 240 through the first main channel MCH1. The memory control unit 211 may activate or deactivate the first memory device 230 and the second memory device 240 by activating or deactivating a first chip select signal CS1 and a second chip select signal CS2.

The memory control unit 211 may control the third memory device 270 and the fourth memory device 280 by providing control signals (for example, commands and addresses) through a second main channel MCH2. When storing data, the memory control unit 211 may provide data to the third memory device 270 or the fourth memory device 280 through the second main channel MCH2. Also, in when reading data, the memory control unit 211 may be provided with data from the third memory device 270 or the fourth memory device 280 through the second main channel MCH2. The memory control unit 211 may activate or deactivate the third memory device 270 and the fourth memory device 280 by activating or deactivating a third chip select signal CS3 and a fourth chip select signal CS4.

The first selection unit 221 may activate any one of a first sub channel SCH11 and a second sub channel SCH12, based on the first chip select signal CS1 and the second chip select signal CS2. That is to say, the first selection unit 221 may electrically couple any one of the first sub channel SCH11 and the second sub channel SCH12 with the first main channel MCH1, based on the first chip select signal CS1 and the second chip select signal CS2. For example, when the first chip select signal CS1 is activated, the first selection unit 221 may connect the first main channel MCH1 to the first sub channel SCH11, and may disconnect the first main channel MCH1 from the second sub channel SCH12. As another example, when the second chip select signal CS2 is activated, the first selection unit 221 may connect the first main channel MCH1 to the second sub channel SCH12, and may disconnect the first main channel MCH1 from the first sub channel SCH11.

The second selection unit 222 may activate any one of a third sub channel SCH21 and a fourth sub channel SCH22, based on the third chip select signal CS3 and the fourth chip select signal CS4. That is to say, the second selection unit 222 may electrically couple any one of the third sub channel SCH21 and the fourth sub channel SCH22 with the second main channel MCH2, based on the third chip select signal CS3 and the fourth chip select signal CS4. For example, when the third chip select signal CS3 is activated, the second selection unit 222 may connect the second main channel MCH2 to the third sub channel SCH21, and may disconnect the second main channel MCH2 from the fourth sub channel SCH22. As another example, when the fourth chip select signal CS4 is activated, the second selection unit 222 may connect the second main channel MCH2 to the fourth sub channel SCH22, and may disconnect the second main channel MCH2 from the third sub channel SCH21.

The first memory device 230 to the fourth memory device 280 may operate as the storage media of the data storage device 200. Each of the first memory device 230 to the fourth memory device 280 may be configured by a volatile memory which loses the data stored therein when power is off or a nonvolatile memory which retains the data stored therein even without power. The volatile memory may include a static random access memory (SRAM) or a dynamic random access memory (DRAM). The nonvolatile memory may include a NAND flash memory, a NOR flash memory, a ferroelectric random access memory (FRAM), a magnetoresistive random access memory (MRAM), a phase change random access memory (PCRAM) or a resistive random access memory (ReRAM).

The first memory device 230 may be activated or deactivated in response to the first chip select signal CS1, and the second memory device 240 may be activated or deactivated in response to the second chip select signal CS2. The first memory device 230 which is activated in response to the first chip select signal CS1 may be provided with a control signal or data from the memory control unit 211 or provide the data read from memory cells to the memory control unit 211 through the first main channel MCH1 and the first sub channel SCH11. The second memory device 240 which is activated in response to the second chip select signal CS2 may be provided with a control signal or data from the memory control unit 211 or provide the data read from memory cells to the memory control unit 211, through the first main channel MCH1 and the second sub channel SCH12. In other words, the first memory device 230 and the second memory device 240 may share the first main channel MCH1.

The third memory device 270 may be activated or deactivated in response to the third chip select signal CS3, and the fourth memory device 280 may be activated or deactivated in response to the fourth chip select signal CS4. The third memory device 270 which is activated in response to the third chip select signal CS3 may be provided with a control signal or data from the memory control unit 211 or provide the data read from memory cells to the memory control unit 211, through the second main channel MCH2 and the third sub channel SCH21. The fourth memory device 280 which is activated in response to the fourth chip select signal CS4 may be provided with a control signal or data from the memory control unit 211 or provide the data read from memory cells to the memory control unit 211, through the second main channel MCH2 and the fourth sub channel SCH22. In other words, the third memory device 270 and the fourth memory device 280 may share the second main channel MCH2.

A channel which is configured by one or more signal lines may have load capacitance in proportion to the width, length and number of signal lines. If the memory devices 230 to 280 share the main channels MCH1 and MCH2 without the selection unit 220, the load capacitance of channels (that is, main channels and sub channels electrically coupled thereto) between the memory control unit 211 and the memory devices 230 to 280 may increase. This means that power consumption necessary for signal loading on the channels may increase.

According to the embodiment, since only the first main channel MCH1 which is electrically coupled with the memory control unit 211 and a sub channel SCH11 or SCH12 which is electrically coupled with an activated memory device 230 or 240 are electrically coupled with each other by the switching operation of the first selection unit 221 and only the second main channel MCH2 which is electrically coupled with the memory control unit 211 and a sub channel SCH21 or SCH22 which is electrically coupled with an activated memory device 270 or 280 are electrically coupled with each other by the switching operation of the second selection unit 222, the load capacitance of channels to be driven by the memory control unit 211 to provide signals may be decreased. This means that not only power consumption necessary for signal loading may be decreased but also signals may be stably transmitted through the channels.

When the first chip select signal CS1 and the fourth chip select signal CS4 are activated and the second chip select signal CS2 and the third chip select signal CS3 are deactivated, the first main channel MCH1 and the first sub channel SCH11 may be electrically coupled with each other by the switching operation of the first selection unit 221, and the second main channel MCH2 and the fourth sub channel SCH22 may be electrically coupled with each other by the switching operation of the second selection unit 222. As shown in FIG. 4, the load capacitance of channels to be driven by the memory control unit 211 to provide signals may be determined based on only the load capacitance of the first main channel MCH1, the second main channel MCH2, the first sub channel SCH11 and the fourth sub channel SCH22, excluding the load capacitance of the second sub channel SCH12 and the third sub channel SCH21.

FIG. 5 is a block diagram illustrating an example of the controller of the data storage device shown in FIG. 3. Referring to FIG. 5, the controller 210 may include a memory control unit 211, a host interface unit 212, an error correction code (ECC) unit 213, a control unit 214, and a RAM 215.

The memory control unit 211 may provide control signals (for example, commands and addresses) to the memory devices 230 to 280 under the control of the control unit 214. The memory control unit 211 may exchange data with the memory devices 230 to 280.

The host interface unit 212 may interface a host device and the data storage device 200 in correspondence to the protocol of the host device. For example, the host interface unit 212 may be configured to communicate with the host device through any one of universal serial bus (USB), universal flash storage (UFS), multimedia card (MMC), parallel advanced technology attachment (DATA), serial advanced technology attachment (SATA), small computer system interface (SCSI), serial attached SCSI (SAS), peripheral component interconnection (PCI) and PCI express (PCI-E) protocols.

The ECC unit 213 may generate parity data based on the data transmitted to the memory devices 230 to 280. The generated parity data may be stored in the specified areas of the memory devices 230 to 280. The ECC unit 213 may detect an error of the data read from the memory devices 230 to 280, based on the parity data. When the detected error is within a correctable range, the ECC unit 213 may correct the detected error.

The control unit 214 may analyze and process the signal inputted from the host device. The control unit 214 may control the general operations of the controller 210 in response to a request from the host device. The control unit 214 may control the operations of the function blocks of the controller 210 based on firmware or software for driving the data storage device 200. The RAM 215 may be used as a working memory device of the control unit 214 for driving the firmware or the software.

FIG. 6 is a block diagram illustrating an example of a data storage device in accordance with an embodiment of the present invention. FIG. 7 is a block diagram explaining the load capacitance of input/output buses activated in the data storage device shown in FIG. 6.

A data storage device 300 may include a controller 310, a first multichip package 350, and a second multichip package 390. The first multichip package 350 may include a first selection unit 320, a first memory chip 330, and a second memory chip 340. The second multichip package 390 may include a second selection unit 360, a third memory chip 370, and a fourth memory chip 380.

The controller 310 may control the general operations of the data storage device 300 through driving of the firmware or the software loaded on a working memory device (not shown) which is disposed in the controller 310. The controller 310 may decode or drive a code-type instruction or algorithm such as firmware or software. The controller 310 may be realized by hardware or a combination of hardware and software. The controller 310 may be configured by a micro control unit (MCU), a central processing unit (CPU), or the like.

The controller 310 may control the first multichip package 350 by providing control signals (for example, commands and addresses) through a first external input/output bus EXIOB1. When storing data, the controller 310 may provide data to the first multichip package 350 through the first external input/output bus EXIOB1. Also, when reading data, the controller 310 may be provided with data from the first multichip package 350 through the first external input/output bus EXIOB1. The controller 310 may activate one of the first memory chip 330 and the second memory chip 340 of the first multichip package 350 by activating one of a first chip select signal CS1 and a second chip select signal CS2.

The controller 310 may control the second multichip package 390 by providing control signals (for example, commands and addresses) through a second external input/output bus EXIOB2. When storing data, the controller 310 may provide data to the second multichip package 390 through the second external input/output bus EXIOB2. Also, when reading data, the controller 310 may be provided with data from the second multichip package 390 through the second external input/output bus EXIOB2. The controller 310 may activate one of the third memory chip 370 and the fourth memory chip 380 of the second multichip package 390 by activating one of a third chip select signal CS3 and a fourth chip select signal CS4.

Each of the first multichip package 350 and the second multichip package 390 may be a memory device in which at least two memory chips (or memory dies) are packaged. The first multichip package 350 and the second multichip package 390 may operate as the storage media of the data storage device 300. Each of the first memory chip 330 and the second memory chip 340 which are included in the first multichip package 350 and the third memory chip 370 and the fourth memory chip 380 which are included in the second multichip package 390 may be configured by a volatile memory which loses the data stored therein when power is off or a nonvolatile memory which retains the data stored therein even though power is off. The volatile memory may include a static random access memory (SRAM) or a dynamic random access memory (DRAM). The nonvolatile memory may include a NAND flash memory, a NOR flash memory, a ferroelectric random access memory (FRAM), a magnetoresistive random access memory (MRAM), a phase change random access memory (PCRAM) or a resistive random access memory (ReRAM).

The first selection unit 320 may activate any one of a first internal input/output bus INIOB11 and a second internal input/output bus INIOB12, based on the first chip select signal CS1 and the second chip select signal CS2. That is to say, the first selection unit 320 may electrically couple any one of the first internal input/output bus INIOB11 and the second internal input/output bus INIOB12 with the first external input/output bus EXIOB1, based on the first chip select signal CS1 and the second chip select signal CS2. For example, when the first chip select signal CS1 is activated, the first selection unit 320 may connect the first external input/output bus EXIOB1 to the first internal input/output bus INIOB11, and may disconnect the first external input/output bus EXIOB1 from the second internal input/output bus INIOB12. As another example, when the second chip select signal CS2 is activated, the first selection unit 320 may connect the first external input/output bus EXIOB1 to the second internal input/output bus INIOB12, and may disconnect the first external input/output bus EXIOB1 from the first internal input/output bus INIOB11.

The first memory chip 330 may be activated or deactivated in response to the first chip select signal CS1, and the second memory chip 340 may be activated or deactivated in response to the second chip select signal CS2. The first memory chip 330 which is activated in response to the first chip select signal CS1 may be provided with a control signal or data from the controller 310 or provide the data read from memory cells to the controller 310, through the first external input/output bus EXIOB1 and the first internal input/output bus INIOB11. The second memory chip 340 which is activated in response to the second chip select signal CS2 may be provided with a control signal or data from the controller 310 or provide the data read from memory cells to the controller 310, through the first external input/output bus EXIOB1 and the second internal input/output bus INIOB12. In other words, the first memory chip 330 and the second memory chip 340 may share the first external input/output bus EXIOB1.

The second selection unit 360 may activate any one of a third internal input/output bus INIOB21 and a fourth internal input/output bus INIOB22, based on the third chip select signal CS3 and the fourth chip select signal CS4. That is to say, the second selection unit 360 may electrically couple any one of the third internal input/output bus INIOB21 and the fourth internal input/output bus INIOB22 with the second external input/output bus EXIOB2, based on the third chip select signal CS3 and the fourth chip select signal CS4. For example, when the third chip select signal CS3 is activated, the second selection unit 360 may connect the second external input/output bus EXIOB2 to the third internal input/output bus INIOB21, and may disconnect the second external input/output bus EXIOB2 from the fourth internal input/output bus INIOB22. As another example, when the fourth chip select signal CS4 is activated, the second selection unit 360 may connect the second external input/output bus EXIOB2 to the fourth internal input/output bus INIOB22 and may disconnect the second external input/output bus EXIOB2 from the third internal input/output bus INIOB21.

The third memory chip 370 may be activated or deactivated in response to the third chip select signal CS3, and the fourth memory chip 380 may be activated or deactivated in response to the fourth chip select signal CS4. The third memory chip 370 which is activated in response to the third chip select signal CS3 may be provided with a control signal or data from the controller 310 or provide the data read from memory cells to the controller 310, through the second external input/output bus EXIOB2 and the third internal input/output bus INIOB21. The fourth memory chip 380 which is activated in response to the fourth chip select signal CS4 may be provided with a control signal or data from the controller 310 or provide the data read from memory cells to the controller 310, through the second external input/output bus EXIOB2 and the fourth internal input/output bus INIOB22. In other words, the third memory chip 370 and the fourth memory chip 380 may share the second external input/output bus EXIOB2.

An input/output bus which is configured by one or more signal lines may have load capacitance in proportion to the width, length and number of the signal lines. If the memory chips 330 to 380 share the external′ input/output buses EXIOB1 and EXIOB2 without the selection units 320 and 360, the load capacitance of input/output buses (that is, external input/output buses and internal input/output buses electrically coupled thereto) between the controller 310 and the memory chips 330 to 380 may increase. This means that power consumption necessary for signal loading on the input/output buses may increase.

According to the embodiment, since only the first external input/output bus EXIOB1 which is electrically coupled with the controller 310 and an internal input/output bus INIOB11 or INIOB12 which is electrically coupled with an activated memory chip 330 or 340 of the first multichip package 350 are electrically coupled with each other by the switching operation of the first selection unit 320 and only the second external input/output bus EXIOB2 which is electrically coupled with the controller 310 and an internal input/output bus INIOB21 or INIOB22 which is electrically coupled with an activated memory chip 370 or 380 of the second multichip package 390 are electrically coupled with each other by the switching operation of the second selection unit 350, the load capacitance of input/output buses (that is, external input/output buses and internal input/output buses electrically coupled thereto) to be driven by the controller 310 to provide signals may be decreased. This means that not only power consumption necessary for signal loading may be decreased but also signals may be stably transmitted through the input/output buses.

When the second chip select signal CS2 and the third chip select signal CS3 are activated and the first chip select signal CS1 and the fourth chip select signal CS4 are deactivated, the first external input/output bus EXIOB1 and the second internal input/output bus INIOB12 may be electrically coupled with each other by the switching operation of the first selection unit 320 of the first multichip package 350 and the second external input/output bus EXIOB2 and the third internal input/output bus INIOB21 may be electrically coupled with each other by the switching operation of the second selection unit 360 of the second multichip package 390. As shown in FIG. 7, the load capacitance of input/output buses to be driven by the controller 310 to provide signals may be determined based on only the load capacitance of the first external input/output bus EXIOB1, the second external input/output bus EXIOB2, the second internal input/output bus INIOB12 and the third internal input/output bus INIOB21, excluding the load capacitance of the first internal input/output bus INIOB11 and the fourth internal input/output bus INIOB22.

FIG. 8 is a block diagram illustrating an example of a computer system in which the memory system or the data storage device in accordance with the embodiment is mounted. Referring to FIG. 8, a computer system 3000 may include a network adaptor 3100, a central processing unit 3200, a data storage device 3300, a RAM 3400, a ROM 3500 and a user interface 3600, which are electrically coupled to a system bus 3700. The data storage device 3300 may be configured by the memory system 100 shown in FIG. 1, the data storage device 200 shown in FIG. 3 or the data storage device 300 shown in FIG. 6.

The network adaptor 3100 may provide interfacing between the computer system 3000 and external networks. The central processing unit 3200 may perform general operations for driving an operating system or an application program loaded on the RAM 3400.

The data storage device 3300 may store general data necessary in the computer system 3000. For example, an operating system for driving the computer system 3000, an application program, various program modules, program data and user data may be stored in the data storage device 3300.

The RAM 3400 may be used as a working memory device of the computer system 3000. Upon booting, the operating system, the application program, the various program modules and the program data necessary for driving programs, which are read from the data storage device 3300, may be loaded on the RAM 3400.

A BIOS (basic input/output system) which is activated before the operating system is driven may be stored in the ROM 3500.

Information exchange between the computer system 3000 and a user may be implemented through the user interface 3600.

Although not shown in a drawing, the computer system 3000 may further include devices such as an application chipset, a camera image processor, and so forth.

While various embodiments have been described above, it will be understood to those skilled in the art that the embodiments described are examples only. Accordingly, the memory system and the data storage device described herein should not be limited based on the described embodiments.

What is claimed is:

1. A memory system comprising:
a first memory device and a second memory device suitable for outputting and receiving signals through a first and a second sub input/output lines, respectively;
a controller suitable for outputting and receiving signals to and from the first memory device and the second memory device, through a main input/output line; and
a selection unit suitable for electrically coupling the main input/output line with one of the first and the second sub input/output lines, through which an activated one of the first memory and second memory devices outputs and receives signals.

2. The memory system according to claim 1, wherein the selection unit selects the one of the first and second sub input/output lines to be electrically coupled with the main input/output line, based on a first select signal for activating the first memory device and a second select signal for activating the second memory device.

3. The memory system according to claim 1, wherein the controller outputs a control signal or data, or receives data from the activated one of the first memory and second memory devices, through the main input/output line and the one of the first and second sub input/output lines.

4. The memory system according to claim 1, wherein the selection unit is electrically coupled with the controller through the main input/output line, electrically coupled with the first memory device through the first sub input/output line, and electrically coupled with the second memory device through the second sub input/output line.

5. A data storage device comprising:
a memory control unit;
a first memory device suitable for transmitting and receiving signals with the memory control unit through a first sub channel;
a second memory device suitable for transmitting and receiving signals with the memory control unit through a second sub channel; and
a first selection unit suitable for activating one of the first sub channel and the second sub channel, based on a first select signal for activating the first memory device and a second select signal for activating the second memory device.

6. The data storage device according to claim 5,
wherein the memory control unit transmits and receives signals with the first memory device and the second memory device, through a first main channel, and
wherein the first selection unit electrically couples an activated one of the first and second sub channels with the first main channel.

7. The data storage device according to claim 6, further comprising:
a third memory device suitable for transmitting and receiving signals with the memory control unit through a third sub channel;
a fourth memory device suitable for transmitting and receiving signals with the memory control unit through a fourth sub channel; and
a second selection unit suitable for activating one of the third sub channel and the fourth sub channel, based on a third select signal for activating the third memory device and a fourth select signal for activating the fourth memory device.

8. The data storage device according to claim 7,
wherein the memory control unit transmits and receives signals with the third memory device and the fourth memory device, through a second main channel, and
wherein the second selection unit electrically couples an activated one of the third and the fourth sub channel with the second main channel.

9. The data storage device according to claim 5, further comprising:
a controller including a host interface unit, a control unit and a random access memory,
wherein the memory control unit and the First selection unit are included in the controller.

10. A data storage device comprising:
a first multichip package including a first memory chip, a second memory chip, and a first selection unit which activates one of a first internal data bus electrically coupled to the first memory chip and a second internal data bus electrically coupled to the second memory chip; and
a controller suitable for controlling the first multichip package for storing and reading of data.

11. The data storage device according to claim 10, wherein the first selection unit electrically couples an activated one of the first internal data bus and the second internal data bus with a first external data bus, based on a first select signal for activating the first memory chip and a second select signal for activating the second memory chip.

12. The data storage device according to claim 11, wherein the controller provides a control signal or data to the first memory chip or the second memory chip which is activated, or is provided with data from the first memory chip or the second memory chip which is activated, through the first external data bus.

13. The data storage device according to claim 11, further comprising:
a second multichip package including a third memory chip, a fourth memory chip, and a second selection unit which activates one of a third internal data bus electrically coupled to the third memory chip and a fourth internal data bus electrically coupled to the fourth memory chip.

14. The data storage device according to claim 13, wherein the second selection unit electrically couples an activated one of the third internal data bus and the fourth internal data bus with a second external data bus, based on a third select signal for activating the third memory chip and a fourth select signal for activating the fourth memory chip.

15. The data storage device according to claim 14, wherein the controller provides a control signal or data to the third memory chip or the fourth memory chip which is activated, or is provided with data from the third memory chip or the fourth memory chip which is activated, through the second external data bus.
